(19) United States
(12) Patent Application Publication
(10) Pub. No.: US 2006/0086884 A1
(43) Pub. Date: Apr. 27, 2006

(54) Supporting structure for beach umbrellas and the like

(75) Inventor: Celso Meirelles de Oliveira Santos, Rio de Janeiro (BR)

Correspondence Address: D. PETER HOCHBERG CO. L.P.A., 1940 EAST 6TH STREET, CLEVELAND, OH, 44114, US

(73) Assignee: Luigi Fernando Milone, Rio de Janeiro (BR)

(21) Appl. No.: 11/259,341

(22) Filed: Oct. 25, 2005

(30) Foreign Application Priority Data
Oct. 25, 2004 (BR) MU 8402617-0

(51) Int. Cl. F16M 13/00

(52) U.S. Cl. 248/530

(57) ABSTRACT

A supporting stem for a beach umbrella composed of a helical fixing element comprising an elliptical-toroidal material which revolves the surface of a central shaft, the elliptical-toroidal material being interconnected by a lamellar surface of contiguous helical revolution, made from a single material, whose male-type fitting cylindrical upper terminal presents symmetrically two holes for fixing the supporting stem in the soil and coupling the lower stem to an upper stem; the lower part of elliptical-toroidal body includes a thin and sharp termination for facilitating penetration into the soil. The helical stem with the hard central structure and the helical support structure provide mechanical resistance to twist when penetrating the soil by threading and maintain inflection resistance in relation to the wind power action after the beach umbrella installation to avoid plastic deformation of the material.

### BACKGROUND OF THE INVENTION

1. Field of the Invention

The present invention relates to supporting structure and the like for a beach umbrella or the like, and in particular to structure on the stem of a beach umbrella or the like to embed the base of the stem in the sand or other soil, which reduces or eliminates both twisting and bending of the stem.

2. Description of the Prior Art

Beach umbrellas and the like generally have a cylindrical supporting stem which is planted in the sand or loamy soil so that the umbrella will remain upright to provide the shade desired.

The cylindrical stem oftentimes does not remain upright, due to wind and impact, and the umbrella stem tends to fall over or be bent. A common way of implanting a beach umbrella stem in the soil is by driving its end into the soil, but this can be ineffective and could break the stem. Moreover, women and children often cannot use this method. Devices for implanting the umbrella in sand or other soil are bulky and/or ineffective. Devices for holding posts in the ground, such as spade-shaped devices, are heavy, and apparatus for holding Christmas trees and the like in an upright position are bulky and fairly expensive.

### SUMMARY OF THE INVENTION

The present invention is an improvement of devices for use for supporting the stem of a beach umbrella in sandy, loamy soils. The invention enables the user to efficiently and accurately penetrate and fix the lower end of the supporting stem of a beach umbrella by way of a threading helical element, for avoiding or reducing the twisting or inflection of the supporting stem, with a structure which is easy to use to set up and enjoy the sun-protecting device.

It is an object of the present invention to provide an improvement of devices for inserting the stem of a beach umbrella into the ground by providing threading on the end portion with the features of stability, safety, reliability, ease of use and low manufacturing costs.

It is well known that extended exposure of the skin directly to the sun's rays causes severe injuries, requiring people to use various kinds of protection. The most traditional, practical, popular and simplest way of protection from the suns' rays is still the use of a beach umbrella. Chemical products, such as sunscreen lotions and creams for the skin, do not always offer the necessary and sufficient protection to prevent the user in general from suffering injuries to the skin from long sun exposure.

However, a big drawback of a beach umbrella is the method used for penetrating and fixing its lower support stem into the ground. Some usual procedures for installation of a beach umbrella are well known, one such procedure being the use of the support stem as an impact tool against the soil, as mentioned earlier. This procedure is not always satisfactory with respect to safety and reliability, since it is an unsuitable way of using the support stem as a tool and which can damage the umbrella.

The present invention involves a helical penetration concept which is applied to the lower end (the end to be implanted into the soil) of the supporting stem of a beach umbrella. This provides an effective way of penetrating the soil to fix the stem therein, and then turning the stem manually or by means of an appropriate device to in effect screw the supporting stem into the soil.

The helical concept for installation of a beach umbrella provides the stability sought for the supporting stem and fixes it in the ground so that it can withstand intense wind power, whether it is continuous or gusts, to provide improved safety and stability to the beach umbrella or any other similar device having a stem with a useful portion at its upper end.

It has been found that the helical concept discussed below is effective both in sand and in compact soil, and can withstand both intermittent or intense wind flurries which otherwise would cause twisting, inflections and oscillations of the stem.

The invention in its preferred form uses a large central shaft having a helical revolution surface built on the lower end of the supporting stem to provide a solid mechanical element, able to penetrate the soil by a threading action to firmly penetrate and fix the support stem in the ground, and which can be removed by turning it in an unthreading fashion.

A beach umbrella stem can be prepared according to the invention by means of an elliptical-toroidal body which revolves on the surface of the central shaft, to be connected to the central shaft with a contiguous helical revolution in lamellar form, using the same material as was used in the stem shaft. Two symmetrical holes can be provided in the shaft for fixing the lower end of the support stem in the sand or other soil and coupling the beach umbrella's supporting stem therein. The lower part of the elliptical-toroidal body includes a sharp and thin end for penetration into the soil area.

The lamellar surface of contiguous helical revolution adds to the helical fixing element, which lessens the effort for threading the support stem into the soil because of its small thickness. The small thickness of the lower end (“upper” and “lower” refer to those parts of the umbrella and stem as they are located when the umbrella is standing upright on the ground) reduces the soil material that is urged into the ground during the twisting action.

The hard central structure grants additional twist mechanical resistance to the helical fixing structure when penetrating the soil by threading, maintaining the same attribute regarding the inflection resistance pertinent to the wind power action, after the beach umbrella installation, and preventing plastic deformation of the material.

By use of the improved helical fixing structure, a beach umbrella can be installed in any natural kind of soil in a simple manner, due to the structure revolving about the central shaft.

It should also be understood that the device is extremely simple in its construction, its manufacture being therefore readily feasible and economical. The new shape comprises nonmovable parts in the lower stem, and the helical structure is preferably oriented clockwise. It is composed of a hard column of high mechanical resistance and made from a large profile of an elliptical-toroidal construction, containing a sharp and thin end at its extreme end for better penetration into the soil, resulting in a lessening of physical effort and better vertical stability.

Because the helical structure is preferably made from light, simple, long-lasting and strong materials, it provides the user with quality, simplicity and resistance, even when used in environments with intense sun radiation and blowing sea air, which is typical in coastal areas.

Another novel feature of the present invention is the single-block elliptical-toroidal structure which revolves around its central axle and constitutes a hard structure column providing resistance to inflections and twists which occur in installation and use conditions.

### BRIEF DESCRIPTION OF THE DRAWINGS

The invention may take physical form in certain parts and arrangement of parts, the preferred embodiment of which will be described in detail in the specification and illustrated in the accompanying drawings which form a part hereof, and wherein:

FIG. 1 shows a front view of the beach umbrella having the helical fixing structure revolved around a hard central shaft.

FIG. 2 shows a side view of the beach umbrella having the helical fixing structure revolved around a hard central shaft.

FIG. 3 shows a top view of the beach umbrella having the helical fixing structure revolved around a hard central shaft.

FIG. 4 shows a downward-looking perspective view from the front of the beach umbrella having the helical fixing structure with hard central shaft.

FIG. 5 shows an upward-looking perspective view of the beach umbrella having the helical fixing structure with hard central shaft.

FIG. 6 shows another downward-looking perspective view from the side of the beach umbrella having the helical fixing structure with hard central shaft.

FIG. 7 shows a cross-sectional view of the beach umbrella having the helical fixing structure with hard central shaft.

FIG. 8 shows a front view of the supporting stem of the beach umbrella having the helical fixing structure with hard central shaft in its lower part.

FIG. 9 shows a side view of the supporting stem of the beach umbrella with the helical fixing structure with hard central shaft in its lower part.

FIG. 10 shows a top frontal perspective view of the supporting stem of the of the beach umbrella with helical fixing structure with hard central shaft in its lower part.

FIG. 11 shows a front view of the supporting stem of the beach umbrella with right-handed threading during a manual procedure for fixing a stem according to the invention into the soil.

FIG. 12 shows a front view of the supporting stem of the beach umbrella buried and fixed in the soil.

FIG. 13 shows a front view of the umbrella in an open position with its stem buried in the soil.

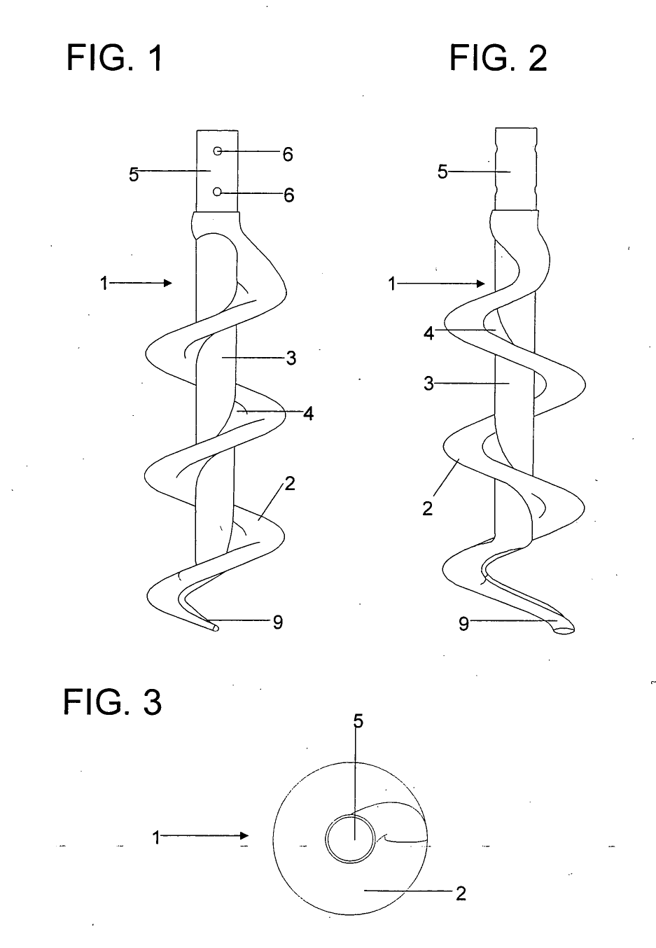

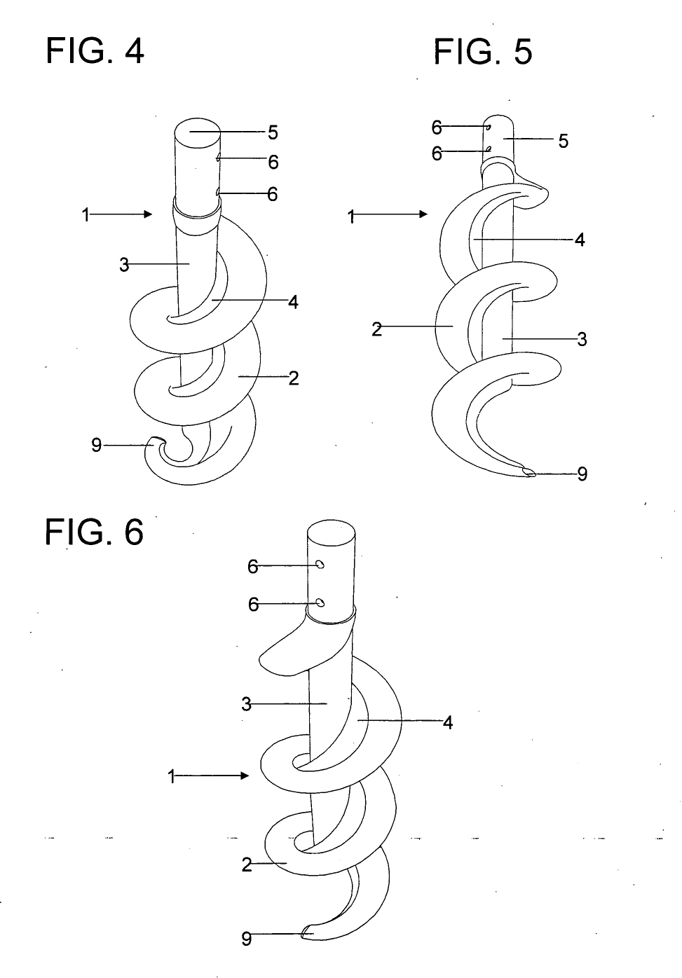

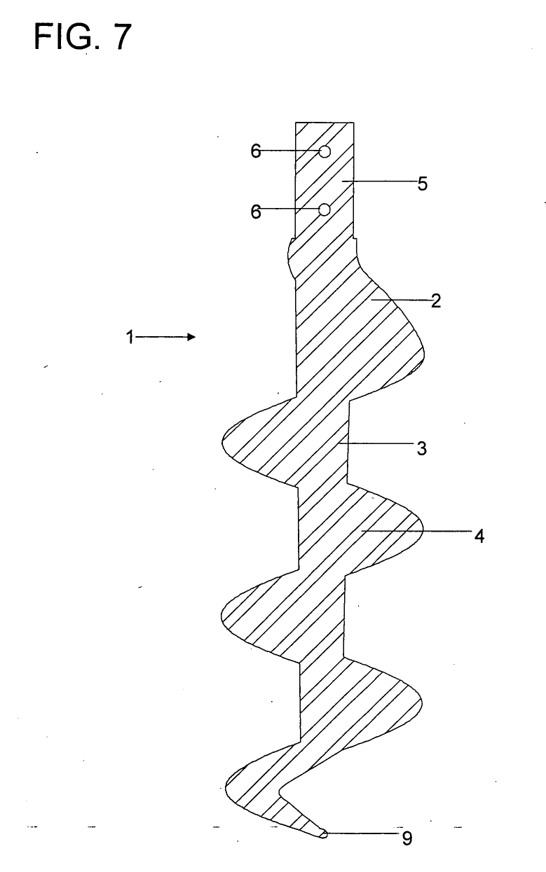

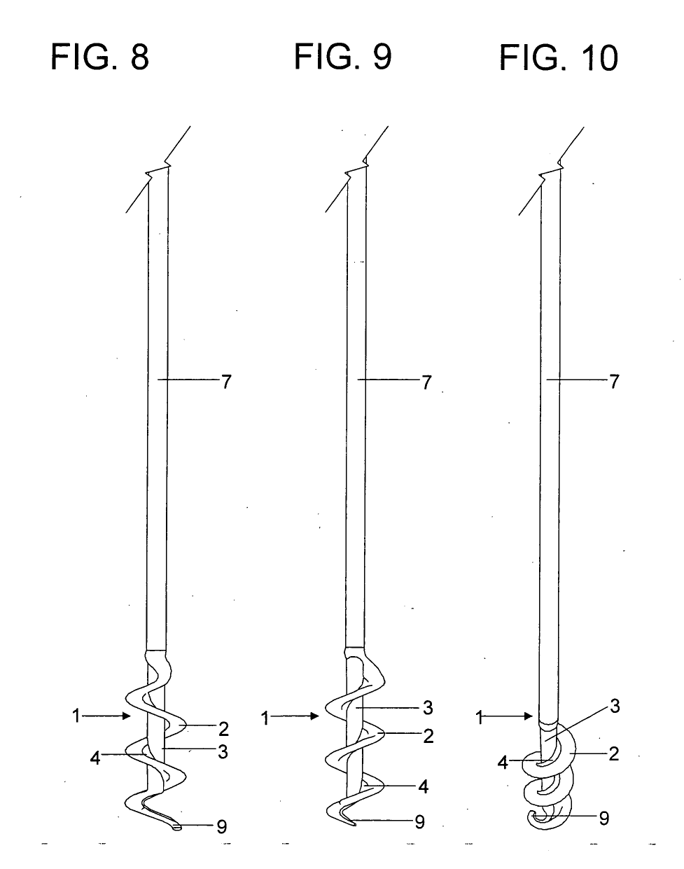

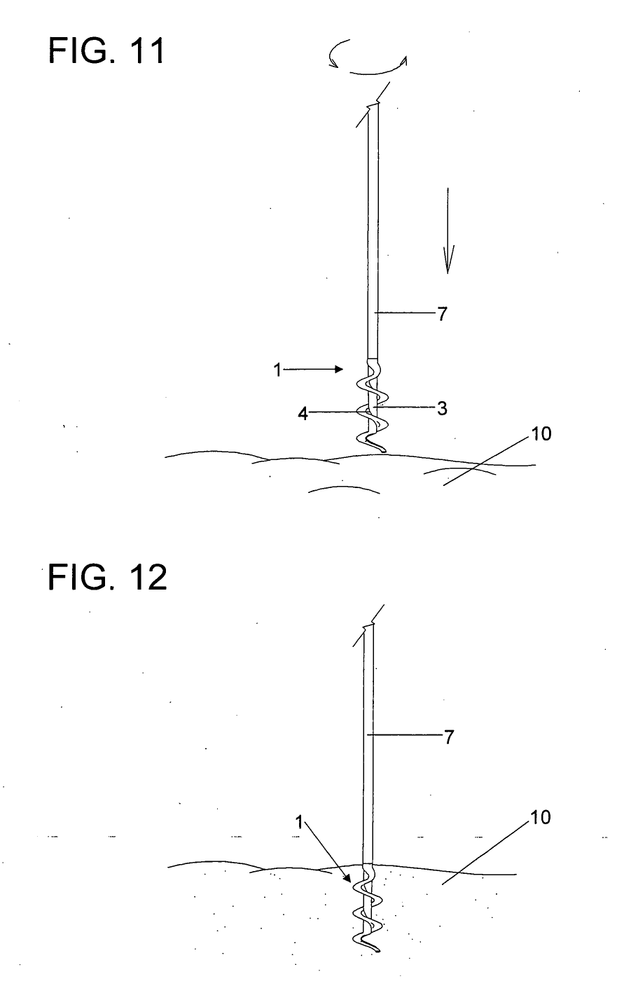

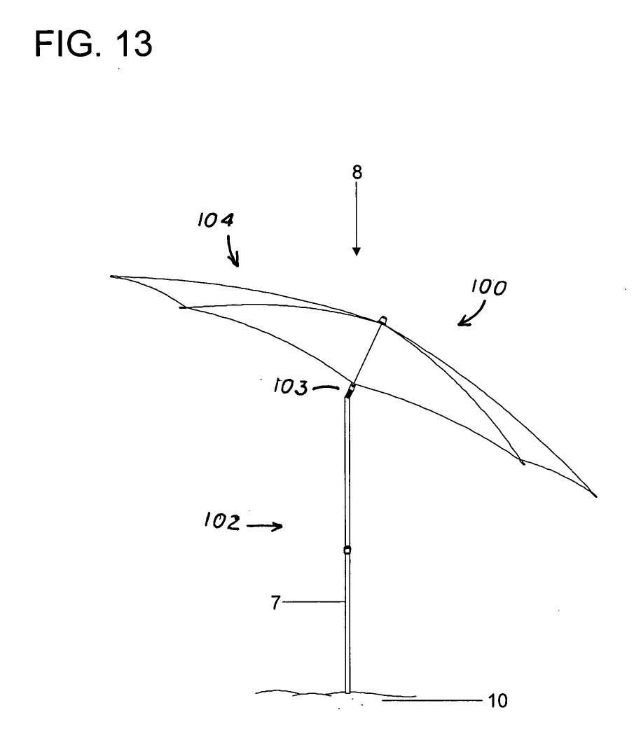

### DETAILED DESCRIPTION OF THE INVENTION

The present invention has as its aim at providing an improved structure for installing and fixing the supporting stem of a beach umbrella in natural soils. Referring to the drawings, a beach umbrella 100 is shown having a stem 102, a tiltable upper stem 103, and an umbrella membrane attached to supporting spokes, which membrane and spokes are collectively identified by numerical identifier 104. Stem 102 is characterized by a helical fixing element 1, comprising an elliptical-toroidal body 2 which revolves around the surface of a central shaft 3. Body 2 is interconnected with shaft 3 by a lamellar structure 4 of a contiguous helical revolution, made from a single material, resulting in a singular body, having a cylindrical upper terminal of a male-type fitting 5. Fitting 5 has two symmetrically located holes 6 for coupling fixing element 1 in a lower stem. In a lower part 2 of elliptical-toroidal body 2 is a thin and sharp termination or lower end 9 for better penetrating the soil 10, which includes sand as normally found on beaches.

The lamellar surface 4 having the contiguous helical revolution adds to the helical fixing element 1 an attribute to lessen the effort to its threading into soil 10, because of its small thickness, and providing a lower tendency to urge or drag the soil material into the soil being penetrated.

Hard central shaft 3 provides to helical fixing element 1 additional mechanical resistance to the twisting as lever stem 7 is threaded into soil 10, while maintaining inflection resistance, to withstand wind power action, and avoids plastic deformation to the material. Beach umbrella 100 is shown in its open condition 8 in FIG. 23, with membrane and spokes 104 unfolded from upper stem 103.

In this manner, the improved helical fixing element 1 of the beach umbrella can be installed in any kind of soil 10 with simplicity, even penetrating soils harder than sand since it has sharp end 9. The helical shape, the elliptical-toroidal surface 2 which revolves around central shaft 3, and the lamellar surface 4 all mechanically facilitate the penetration by lower stem 7 into the soil without requiring significant additional physical effort from the user.

Beach umbrella 100 described above provides the user with an improvement over traditional beach umbrellas, facilitating its use and speeding up the installation process by any person, even if the person has no special skills for such a task.

The invention has been described in detail, with particular emphasis on the preferred embodiment thereof, but variations and modifications within the spirit and scope of the invention may occur to those skilled in the art to which the invention pertains.

I claim:

1. A supporting stem for a beach umbrella or the like, said supporting stem having a lower end for penetrating soil, said supporting stem comprising:
a central shaft; and
a helical fixing element extending from said central shaft, said helical fixing element comprising:
an elliptical-toroidal body revolving around said central shaft; and
a lamellar surface wound around said central shaft for interconnecting said elliptical-toroidal body and said central shaft;
said elliptical-toroidal body at the lower end of said supporting stem having a thin construction compared to the balance of said elliptical-toroidal body and terminating in a sharp point to facilitate the penetration of said supporting stem into the soil.

2. A supporting stem according to claim 1 wherein said supporting stem has an upper end for coupling with an upper stem, and said supporting stem further including at least one hole for engagement with the upper stem to couple said lower stem and said upper stem and to facilitate the fixing of said supporting stem in the soil.

3. A supporting stem according to claim 2 wherein said at least one hole comprises two holes symmetrically disposed in said lower stem for facilitating the coupling of said lower stem with an upper stem and the fixing of said supporting stem in the soil.

4. A supporting stem according to claim 1 wherein said supporting stem is made from a single material.
